(19) United States
(12) Patent Application Publication
(10) Pub. No.: US 2016/0348957 A1
(43) Pub. Date: Dec. 1, 2016

(54) REFRIGERATOR APPLIANCES AND MULLIONS THEREFOR

(71) Applicant: General Electric Company, Schenectady, NY (US)

(72) Inventors: Joel Erik Hitzelberger, Louisville, KY (US); Roger Shawn Nelson, Louisville, KY (US)

(21) Appl. No.: 14/723,621

(22) Filed: May 28, 2015

(51) Int. Cl. F25D 23/02

(52) U.S. Cl. CPC F25D 23/028; F25D 2201/12; F25D 2201/14; B33Y 80/00

(57) ABSTRACT

Refrigerator appliances and mullions therefor are provided. A mullion includes a body formed from an unfoamed thermopolymer material. The body includes an outer non-porous barrier and an inner porous media, the inner porous media including a matrix and one or more voids defined in the matrix.

### FIELD OF THE INVENTION

The present disclosure related generally to refrigerator appliances and mullions utilized with refrigerator appliances, and more particularly to mullions having improved internal structures.

### BACKGROUND OF THE INVENTION

Generally, refrigerator appliances include a cabinet that defines a fresh food chamber for receipt of food items for storage. Many refrigerator appliances further include one or more freezer chambers for receipt of food items for freezing and storage. Various mullions typically divide the various chambers. For example, a stationary mullion can be disposed between the fresh food chamber and freezer chamber. In refrigerator appliances with multiple freezer chambers, a stationary mullion can be disposed between the freezer chambers. In “french door” style refrigerator appliances, an articulating mullion can be mounted to one of the fresh food chamber doors and positioned between the fresh food chamber doors when closed.

Presently known mullions, and in particular articulating mullions, are formed by injection molding a foam into a channel. A cover is then placed over the foam. However, the mullions that result from these processes typically have a variety of disadvantages. For example, warpage such as bowing and twisting can occur during manufacturing due to deformation of the channel. Additionally, shrinkage issues can occur.

The process utilized for manufacturing mullions also has various disadvantages. For example, presently known manufacturing processes utilize a number of separate steps and a variety of discrete components to form the mullion body, thus increasing the time and cost associated with manufacturing a mullion.

Accordingly, improved mullions for use in refrigerator appliances are desired. In particular, mullions having reduced or eliminated warpage and shrinkage issues, and which can be manufactured in a relatively more efficient and cost-effective manner, would be advantageous.

### BRIEF DESCRIPTION OF THE INVENTION

Additional aspects and advantages of the invention will be set forth in part in the following description, or may be apparent from the description, or may be learned through practice of the invention.

In accordance with one embodiment, a refrigerator appliance is provided. The refrigerator appliance includes a cabinet defining a fresh food chamber, and a fresh food door rotatably hinged to the cabinet for accessing the fresh food chamber. The door includes an inner surface, an outer surface and a side surface extending between the inner surface and the outer surface. The refrigerator appliance further includes a mullion having a body formed from an unfoamed thermopolymer material. The body includes an outer non-porous barrier and an inner porous media, the inner porous media including a matrix and one or more voids defined in the matrix.

In accordance with another embodiment, a mullion for use in a refrigerator appliance is provided. The mullion includes a body formed from an unfoamed thermopolymer material. The body includes an outer non-porous barrier and an inner porous media, the inner porous media including a matrix and one or more voids defined in the matrix.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front view of a refrigerator appliance in accordance with one embodiment of the present disclosure;

FIG. 2 provides a front view of the refrigerator appliance of FIG. 1 with refrigerator doors of the refrigerator appliance shown in an open configuration to reveal a fresh food chamber and freezer chambers of the refrigerator appliance;

FIG. 3 provides a perspective view of a fresh food door, a freezer door, and a mullion connected to the fresh food door in accordance with one embodiment of the present disclosure; and

FIG. 4 provides a cross-sectional view of a mullion in accordance with one embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

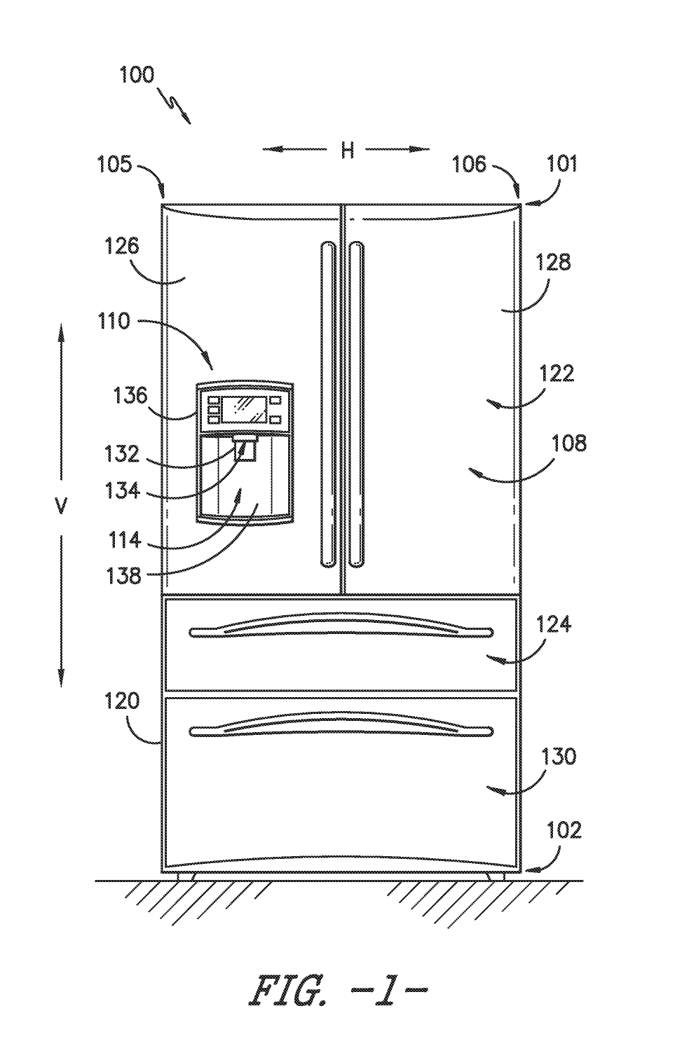

FIG. 1 is a front view of an exemplary embodiment of a refrigerator appliance 100. Refrigerator appliance 100 extends between a top 101 and a bottom 102 along a vertical direction V. Refrigerator appliance 100 also extends between a first side 105 and a second side 106 along a horizontal direction H. Further, refrigerator appliance 100 extends between a front 108 and a back 109 along a transverse direction T, which may be defined perpendicular to the vertical and horizontal directions V, H.

Refrigerator appliance 100 includes a cabinet or housing 120 defining a fresh food chamber 122 and one or more freezer chambers, such as first freezer chamber 124 and second freezer chamber 125, which may be arranged below the fresh food chamber 122 on the vertical direction V. As such, refrigerator appliance 100 may generally be referred to as a bottom mount refrigerator. In the exemplary embodiment, housing 120 also defines a mechanical compartment (not shown) for receipt of a sealed cooling system (not shown). Using the teachings disclosed herein, one of skill in the art will understand that the present invention can be used with other types of refrigerators (e.g., side-by-sides) or a top freezer appliance as well. Consequently, the description set forth herein is for illustrative purposes only and is not intended to limit the invention in any aspect.

Refrigerator doors 126 are rotatably hinged to an edge of housing 120 for accessing fresh food chamber 122. For example, upper and lower hinges may couple each door 126 to the housing 120. It should be noted that while two doors 126 in a “french door” configuration are illustrated, any suitable arrangement of doors utilizing one, two or more doors is within the scope and spirit of the present disclosure. Freezer doors, such as first freezer door 130 and second freezer door 131, are arranged below refrigerator doors 126 for accessing freezer chamber, such as first and second freezer chambers 124, 125, respectively. In the exemplary embodiment, freezer doors 130, 131 are coupled to freezer drawers (not shown) slidably coupled within freezer chambers 124, 125. Such drawers are thus generally “pull-out” drawers in that they can be manually moved into and out of the freezer chambers 124, 125 on suitable slide mechanisms.

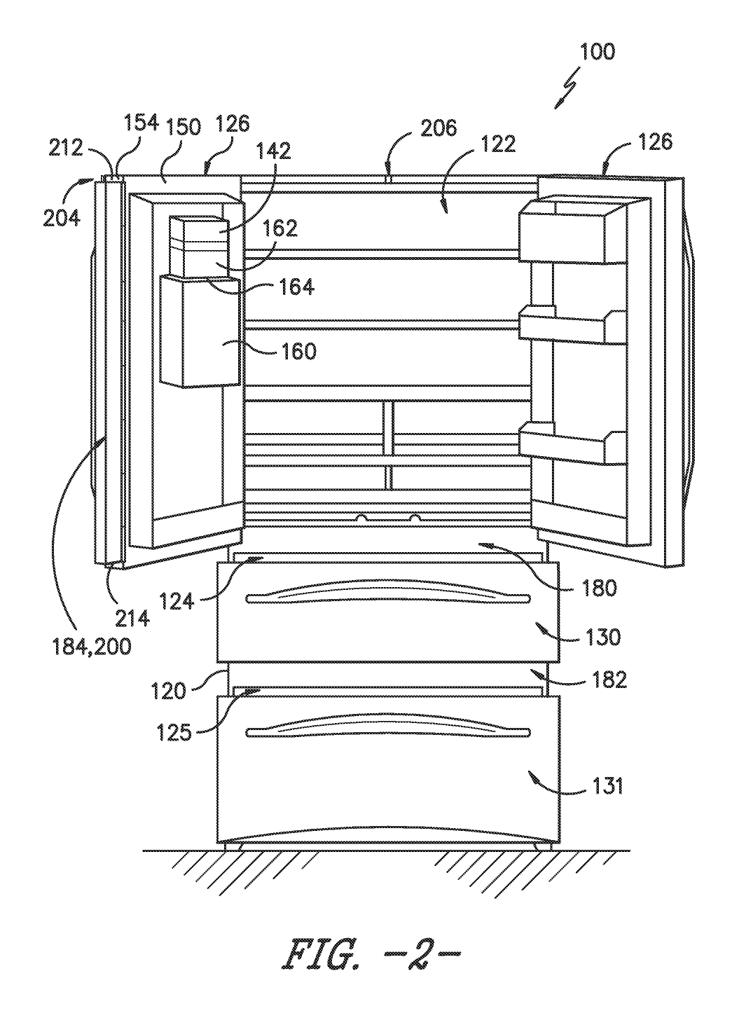

FIG. 2 is a perspective view of refrigerator appliance 100 having refrigerator doors 126 in an open position to reveal the interior of the fresh food chamber 122. Additionally, freezer doors 130, 131 are shown in open positions to reveal the interior of the freezer chambers 124, 125.

A door 126 of the refrigerator appliance 100 may include an inner surface 150 and an outer surface 152. The inner surface 150 generally defines the interior of the fresh food chamber 122 when the door 126 is in a closed position as shown in FIG. 1, while the outer surface 152 is generally opposite the inner surface 150 and defines the exterior of the refrigerator appliance. Side surfaces 154 may extend between and connect the inner surface 150 and outer surface 152.

Refrigerator appliance 100 may further include a dispensing assembly 110 for dispensing water and/or ice. Dispensing assembly 110 includes a dispenser 114 positioned on an exterior portion of refrigerator appliance 100. Dispenser 114 includes a discharging outlet 134 for accessing ice and water. A single paddle 132 is mounted below discharging outlet 134 for operating dispenser 114. A user interface panel 136 is provided for controlling the mode of operation. For example, user interface panel 136 includes a water dispensing button (not labeled) and an ice-dispensing button (not labeled) for selecting a desired mode of operation such as crushed or non-crushed ice.

Discharging outlet 134 and paddle 132 are an external part of dispenser 114, and are mounted in a recessed portion 138 defined in an outside surface of refrigerator door 126. Recessed portion 138 is positioned at a predetermined elevation convenient for a user to access ice or water enabling the user to access ice without the need to bend-over and without the need to access freezer chamber 124. In the exemplary embodiment, recessed portion 138 is positioned at a level that approximates the chest level of a user.

Further components of dispensing assembly 110 are illustrated in FIG. 2. Dispensing assembly 110 includes an insulated housing 142 mounted to door 126. Due to the insulation which encloses insulated housing 142, the temperature within insulated housing 142 can be maintained at levels different from the ambient temperature in the surrounding fresh food chamber 122.

The insulated housing 142 is constructed and arranged to operate at a temperature that facilitates producing and storing ice. More particularly, the insulated housing 142 contains an ice maker for creating ice and feeding the same to an ice container 160, both of which may be mounted on refrigerator door 126. As illustrated in FIG. 2, container 160 is placed at a vertical position on refrigerator door 126 that will allow for the receipt of ice from a discharge opening 162 located along a bottom edge 164 of insulated housing 142.

Referring still to FIG. 2, various mullions may be provided in refrigerator appliance 100. Mullions generally divide the various chambers of the refrigerator appliance 100 and/or prevent leakage therefrom. For example, a stationary mullion 180 may extend and be disposed between the fresh food chamber 122 and a freezer chamber, such as first freezer chamber 124. A stationary mullion 182 may additionally extend and be disposed between the first freezer chamber 124 and second freezer chamber 125. Such mullions 180, 182 may generally extend along the horizontal direction H between the various chambers, as shown. Additionally, an articulating mullion 184 may extend between the doors 126. Articulating mullion 184 may be connected to one of the doors 126. For example, articulating mullion 184 may be rotatably hinged, via hinges 186, to a door 126. Articulating mullion 184 may generally extend along the vertical direction V, as shown. When in the closed position, articulating mullion 184 may generally be positioned between the doors 126 (along the horizontal direction H) and may prevent leakage between the doors 126.

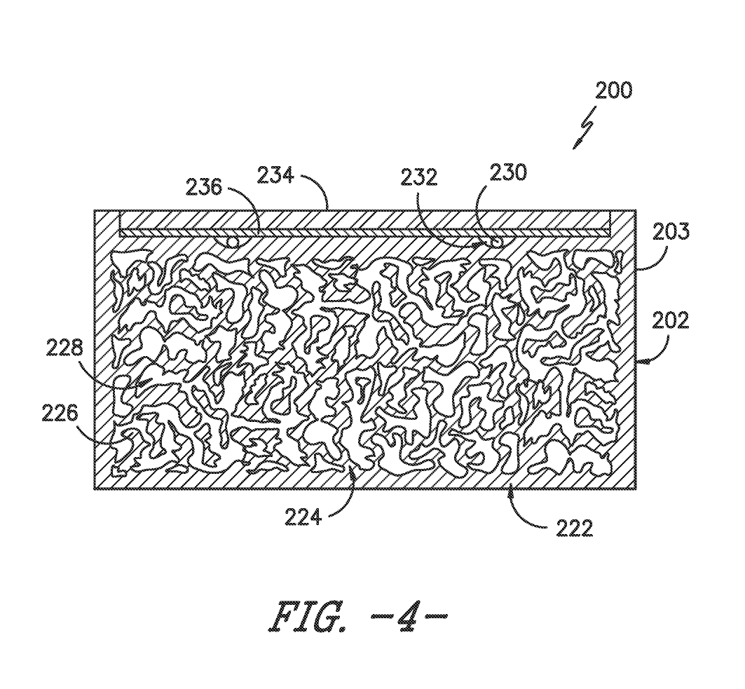

Referring now to FIG. 4, a cross-sectional view of a mullion 200 in accordance with one embodiment of the present disclosure is provided. In exemplary embodiments, mullion 200 may be connected or connectable to a door 126 and/or may, for example, be an articulating mullion such as mullion 184. Alternatively, mullion 200 may be connected or connectable to another suitable component of refrigerator appliance 100. Mullion 200 may be an articulating or otherwise movable mullion, or may be a stationary mullion such as mullion 180 or mullion 182.

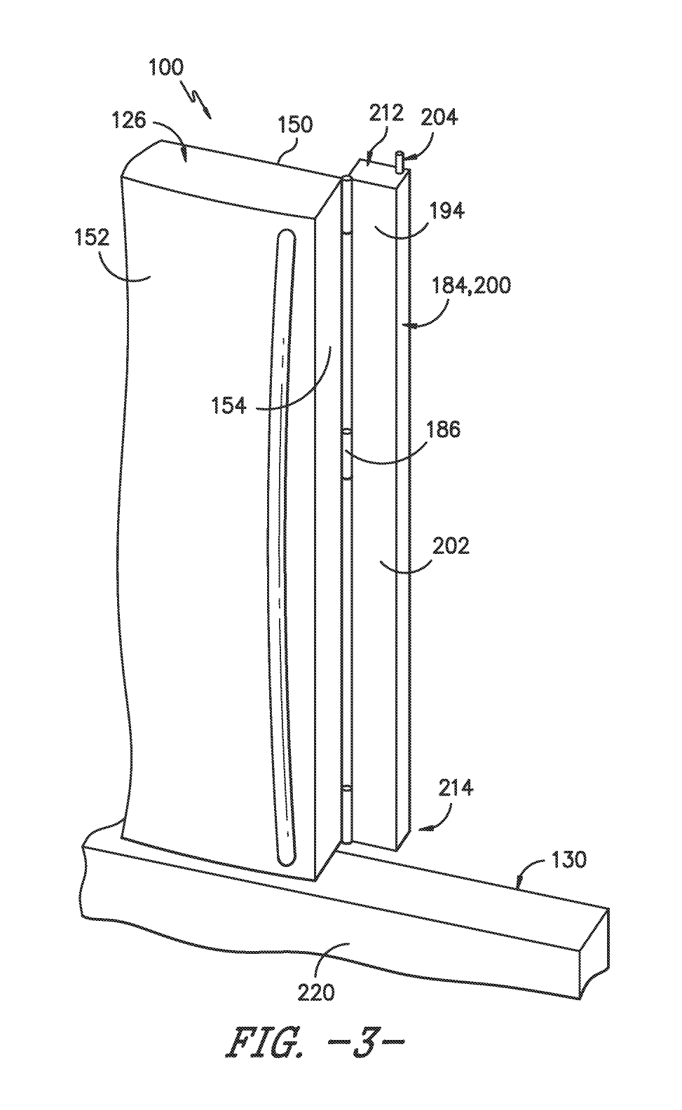

Referring briefly again to FIGS. 2 and 3, mullion 200 may include a body 202, and may further include a tab 204 which extends from the body 204. In embodiments wherein mullion 200 is an articulating mullion, the mullion 200 may additionally include hinges 186 or hinge components thereof.

Body 202 may extend between a first end 212 and a second end 214. In exemplary embodiments, body 202 have a generally rectangular cross-sectional shape, as illustrated in FIG. 4. Alternatively, body 202 may have any other suitable circular, oval, or other polygonal cross-sectional shape.

In exemplary embodiments, tab 204 may extend from first end 212 (as shown in FIGS. 2 and 3) or second end 214. The tab 204 may be sized and shaped to fit within and interact with a groove 206 defined in the housing 120 of refrigerator appliance 100. For example, the groove 206 may include cam surfaces which may interact with tab 204 to cause rotation of the mullion 200 when a door to which the mullion 200 is connected is closed and opened.

Referring again to FIG. 4, body 202 is advantageously formed from an unfoamed thermopolymer material. In general, any suitable thermoplastic or thermoset may be utilized. In exemplary embodiments, for example, the unfoamed thermopolymer material may include acrylonitrile butadiene styrene (“ABS”). The polymer material utilized to form the body 202 is unfoamed, and thus does not include, for example, a foaming agent.

Further, the body 202 may include an outer non-porous barrier 222 and an inner porous media 224. Outer non-porous barrier 222 may generally include the exterior surfaces 203 of the body 202, and may generally surround and encompass the inner porous media 224. Inner porous media 224 may be disposed within the outer non-porous barrier 222 and spaced from the exterior surfaces 203 of the body 202.

A porous media 224 in accordance with the present disclosure includes a matrix 226 and one or more voids 228 (such as a plurality of voids 228) defined in the matrix 226. In exemplary embodiments, various voids 228 are in fluid communication such that fluids can flow between the voids 228.

Notably, in exemplary embodiments, the barriers 222 and porous media 224 of body 202 are formed from the same material and are integral with each other. The present inventors have advantageously utilized current advances in additive manufacturing techniques to develop exemplary embodiments of such bodies 202 and mullions 200 generally in accordance with the present disclosure. While the present disclosure is not limited to the use of additive manufacturing to form such bodies 202 and mullions 200 generally, additive manufacturing does provide a variety of manufacturing advantages, including ease of manufacturing, reduced cost, greater accuracy, etc.

As used herein, the terms “additively manufactured” or “additive manufacturing techniques or processes” refer generally to manufacturing processes wherein successive layers of material(s) are provided on each other to “build-up”, layer-by-layer, a three-dimensional component. The successive layers generally fuse together such as that a monolithic component is formed which may have a variety of integral sub-components. Suitable additive manufacturing techniques in accordance with the present disclosure include, for example, Fused Deposition Modeling (FDM), Selective Laser Sintering (SLS), 3D printing such as by inkjets and laserjets, Sterolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM) and Direct Metal Deposition (DMD).

Notably, the use of additive manufacturing to form the inner porous media 224 is particularly advantageous. For example, the sizes, shapes, uniformity, spacing and frequency of the voids 228 can advantageously be controlled when additive manufacturing is utilized, thus improving the insulating characteristics of the body 202 and allowing the body 202 to be customized for particular usages. These characteristics of the inner porous media 224 of the present disclosure are particularly advantageous over foams which have previously been utilized to form mullions as discussed above. Additionally, the use of additive manufacturing to form bodies 202 as discussed herein advantageously reduces or eliminates warpage and cost and efficiency issues associated with the manufacture of previously known mullions.

In some embodiments, inner porous media 224 may be hermetically sealed, such that fluid leakage therefrom is prevented. Accordingly, fluid within the porous media 224 may advantageously be prevented from escaping the porous media 224. For example, the outer barrier 222 may provide the hermetic seal, as shown, or an intermediate barrier layer may provide the hermetic seal.

In some embodiments, various suitable fluids may be contained within the porous media 224, such as within the voids 228 thereof. For example, in some embodiments, the fluid may be a gas, and in particular exemplary embodiments may be a non-air gas. For example, in some embodiments, an inert gas such as argon may be contained within the voids 228.

Additionally or alternatively, in some embodiments, the voids 228 (and the fluid contained therein) may be at an ambient pressure level (i.e. equal with the pressure outside of the body 202 and mullion 200 generally). In other embodiments, the voids 228 (and the fluid contained therein) may have a vacuum pressure level lower than an ambient pressure level outside of body 202 and mullion 200 generally.

Referring still to FIG. 4, in some embodiments, mullion 200 may include one or more heating elements 230. In exemplary embodiments, heating elements 230 are metal wires which can be heated when electric current is passed therethrough. In exemplary embodiments, the heating elements 230 or portions thereof may be at least partially disposed in channels 232 defined in exterior surfaces 203 of the body 202, such as of the outer non-porous barrier 222. Mullion 200 may further include a cover layer 234, which may for example, be formed from a metal. The cover layer 234 may be positioned proximate an exterior surface 203 of the body 202, such that heating elements 230 are disposed between the exterior surface 203 and the cover layer 234. Additionally, an insulation layer 236, which may for example be formed from aluminum foil or another suitable material, may be positioned between the cover layer 234 and exterior surface 203, such that heating elements 230 are disposed between the exterior surface 203 and the insulation layer 236.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance, comprising:
a cabinet defining a fresh food chamber;
a fresh food door rotatably hinged to the cabinet for accessing the fresh food chamber, the door comprising an inner surface, an outer surface and a side surface extending between the inner surface and the outer surface; and
a mullion having a body formed from an unfoamed thermopolymer material, the body comprising an outer non-porous barrier and an inner porous media, the inner porous media comprising a matrix and one or more voids defined in the matrix.

2. The refrigerator appliance of claim 1, wherein the unfoamed thermopolymer material comprises acrylonitrile butadiene styrene.

3. The refrigerator appliance of claim 1, wherein the one or more voids is a plurality of voids, and wherein voids of the plurality of voids are in fluid communication with each other.

4. The refrigerator appliance of claim 1, wherein the inner porous media is hermetically sealed.

5. The refrigerator appliance of claim 1, wherein the one or more voids of the porous media have a vacuum pressure level lower than an ambient pressure level outside of mullion.

6. The refrigerator appliance of claim 1, wherein the body further comprises a non-air fluid within the one or more voids.

7. The refrigerator appliance of claim 6, wherein the non-air fluid is an inert gas.

8. The refrigerator appliance of claim 1, wherein the outer non-porous barrier and inner porous media are integral with each other.

9. The refrigerator appliance of claim 1, wherein the body is formed through additive manufacturing.

10. The refrigerator appliance of claim 1, wherein the mullion is connected to the fresh food door.

11. The refrigerator appliance of claim 1, wherein the cabinet further defines a freezer chamber, and further comprising a freezer door connected to the cabinet for accessing the freezer chamber.

12. A mullion for use in a refrigerator appliance, the mullion comprising:
a body formed from a unfoamed thermopolymer material, the body comprising:
an outer non-porous barrier; and
an inner porous media, the inner porous media comprising a matrix and one or more voids defined in the matrix.

13. The mullion of claim 12, wherein the unfoamed thermopolymer material comprises acrylonitrile butadiene styrene.

14. The mullion of claim 12, wherein the one or more voids is a plurality of voids, and wherein voids of the plurality of voids are in fluid communication with each other.

15. The mullion of claim 12, wherein the inner porous media is hermetically sealed.

16. The mullion of claim 12, wherein the one or more voids of the porous media have a vacuum pressure level lower than an ambient pressure level outside of mullion.

17. The mullion of claim 12, wherein the body further comprises a non-air fluid within the one or more voids.

18. The mullion of claim 17, wherein the non-air fluid is an inert gas.

19. The mullion of claim 12, wherein the outer non-porous barrier and inner porous media are integral with each other.

20. The mullion of claim 12, wherein the body is formed through additive manufacturing.
